(19) United States
(12) Patent Application Publication
(10) Pub. No.: US 2026/0326739 A1
(43) Pub. Date: Oct. 22, 2026

(54) METHOD FOR OPERATING A VEHICLE DEVICE, AND VEHICLE DEVICE

(71) Applicant: Schaeffler Technologies AG & Co. KG, Herzogenaurach (DE)

(72) Inventors: Marcel ADRIAN, Kehl (DE); Georg GÖPPERT, Hausach (DE)

(73) Assignee: Schaeffler Technologies AG & Co. KG, Herzogenaurach (DE)

(21) Appl. No.: 19/107,663

(22) PCT Filed: Sep. 14, 2023
(86) PCT No.: PCT/DE2023/100688

§ 371 Date: Feb. 28, 2025

(30) Foreign Application Priority Data
Sep. 28, 2022 (DE) 102022124901.8

(51) Int. Cl. B60W 10/08; G06N 3/044; G06N 3/0464; G06N 3/08

(52) U.S. Cl. CPC B60W 10/08; G06N 3/044; G06N 3/0464; G06N 3/08; B60W 2510/087

(57) ABSTRACT

A method (10) for operating a vehicle device (12) on the basis of at least one calculated value (16) is provided, with the method including the following steps: determining the calculated value (16) with an analytical correlation (18) on the basis of at least a first parameter (a) and a second parameter (b) of the vehicle device (12) and an input value (TR) which is associated with the vehicle device (12); calculating the first parameter (a) by a first neural network (20); and calculating the second parameter (b) by a second neural network (22). A vehicle device (12) with which the method is carried out is also provided.

### CROSS-REFERENCE TO RELATED APPLICATIONS

This application is the U.S. National Phase of PCT Appln. No. PCT/DE2023/100688, filed Sep. 14, 2023, which claims priority to DE 102022124901.8, filed Sep. 28, 2022, the entire disclosures of which are incorporated by reference herein.

### TECHNICAL FIELD

The disclosure relates to a method for operating a vehicle device. The disclosure also relates to a vehicle device.

### BACKGROUND

WO 2020 147 870 A1 describes a method for calculating the temperature of a vehicle device, especially a drive unit. The temperature at the respective temperature detection area is calculated using a temperature model.

### SUMMARY

The object of the present disclosure is to operate the vehicle device more efficiently and effectively. In particular, a calculated value, for example the temperature of the vehicle device, should be calculated more accurately and quickly.

At least one of these objects is achieved by a method for operating a vehicle device having one or more of the features disclosed herein. As a result, the calculated value thus determined can enable a more accurate and reliable assessment of the behavior of the vehicle device. The calculated value can be calculated more accurately. This allows the vehicle device to be operated more efficiently and effectively.

The vehicle device can be associated with the vehicle. The vehicle device can be an electric motor, a power electronics, a thermal management system, a battery, and/or a transmission. The vehicle can be an electric vehicle.

The calculated value can change over time. The calculated value can be determined at time intervals. The time intervals can be predefined time intervals. The time intervals can be constant or variable. The time intervals can be adjustable depending on ambient conditions or measured values.

The first parameter can be a variable. The second parameter can be a variable.

By applying the first and second neural network, the first and second parameters can be calculated even for unknown input variables. The first and/or second neural network can have at least one input layer, one or more hidden layers and one output layer.

The first and/or second neural network can be a feed forward neural network (FNN), a recurrent neural network (RNN) or a convolutional neural network (CNN).

In one embodiment, it is advantageous if the input value is a measured and/or calculated physical quantity of the vehicle device. The input value can be a determined calculated value from a temporally previous determination of the calculated value.

In a specific embodiment, it is advantageous if the first and second neural networks are trained separately. This can reduce the complexity and effort required to train neural networks. The first and second neural networks can be trained dependently or independently. The first neural network can be trained with training data that, in particular, completely differs from the training data of the second neural network. The training data of the first and second neural networks can at least partially overlap.

In a specific embodiment, it is advantageous if the determined calculated value forms the input value of a further determination of the calculated value temporally following the determination. The calculated value can be temporally dynamic and thus calculated time-dependently.

In a specific embodiment, it is advantageous if the analytical correlation can be represented by an n-th order polynomial. The analytical correlation can include addition, subtraction, multiplication, and/or division. Often, exact analytical correlations cannot be specified for one or more vehicle devices, for example because the systems are too complex. One possibility is to reduce complexity through simplifying assumptions, grouping of parts/components, or the like. This approach provides approximate analytical correlations. The procedure described here is also applicable for this type of analytical correlation. In this context, the term “system” can be understood to mean parts, groups of parts, components, and/or individual parts of the vehicle device.

One embodiment is advantageous in which the number of parameters of the analytical correlation including the first and second parameters is equal to n+1. Preferably, each parameter can be calculated by a separate neural network, including the first and second neural networks. This can reduce the complexity of the neural networks.

In one embodiment, it is provided that the number of neural networks used to determine the calculated value and including the first and second neural networks is equal to n+1. Also, including the first and second neural networks, less than n+1 or n neural networks can be used. For example, one of the parameters of the analytical correlation can be calculated conventionally. At least one of the parameters of the analytical correlation can be fixed.

In an advantageous embodiment, it is provided that the calculated value indicates a temperature change, the first parameter indicates a heat input, the second parameter indicates a heat dissipation and/or the input value indicates a temperature. The temperature change can be the temperature of an electric motor. The heat input can be caused by electrical energy. Heat dissipation can be conductive, radiative, and/or convective.

Furthermore, at least one of the above-mentioned objects is achieved by a vehicle device having one or more of the features disclosed herein.

In a specific embodiment, it is advantageous if the vehicle device is a drive train device of a drive train of the vehicle. The drive train device can be configured to propel the vehicle. The drive train device can provide a drive power for the propulsion of the motor vehicle.

Further advantages and advantageous embodiments result from the description of the figures and from the drawing.

### BRIEF DESCRIPTION OF THE FIGURES

An embodiment according to the disclosure is described in detail below with reference to the drawing. In the drawings:

FIG. 1 shows a schematic view of a method for operating a vehicle device in a specific embodiment according to the present disclosure.

### DETAILED DESCRIPTION

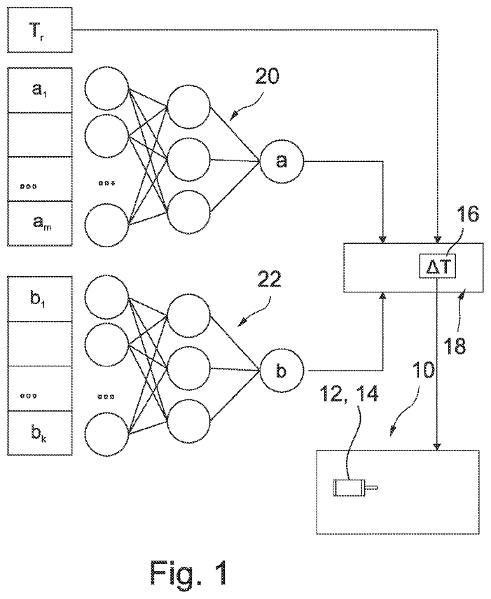

FIG. 1 shows a schematic view of a method for operating a vehicle device. The method 10 for operating a vehicle device 12 is used, for example, in the operation of a vehicle having the vehicle device 12. The vehicle device 12 can be a drive train device 14 of the vehicle, specifically an electric motor of the vehicle.

The operation of the vehicle device 12 depends on a calculated value 16. The calculated value 16 can be a temperature change ΔT of a temperature T of the electric motor. The electric motor can preferably be operated depending on the temperature change ΔT and thus depending on the temperature T calculated from the temperature change ΔT.

The calculated value 16 is calculated by an analytical correlation 18 which depends on at least one first parameter a and second parameter b and an input value T_{R}. For example, the analytical correlation 18 is given by a polynomial of n-th order, in particular first order with n=1 as can be represented in the following:

ΔT=aT_{R}+b

The number of parameters of the analytical correlation 18 is thus equal to n+1. The determined calculated value 16 can form the input value

$${T}_{R}^{t + 1}$$

of a further determination of the calculated value 16 temporally following the determination as follows:

$${T}_{R}^{t + 1} = {T}_{R} + Δ T$$

The first parameter a can designate a heat input Pᵢₙ and the second parameter b can designate a heat dissipation Pₒᵤₜ. The first parameter a can be structured depending on input variables as follows:

$$a = \frac{α A}{{C}_{T}}$$

where the heat transfer coefficient is α, the contact area involved in the heat transfer is A, and the specific heat capacity of the affected components is C_{T}.

The second parameter b can be structured depending on input variables as follows:

$$b = \frac{R}{{C}_{T}}$$

where the electrical resistance is R. The resulting heat output was assumed as follows:

Pᵢₙ=I²R

where the electric current is I.

The first parameter a is calculated by a first neural network 20 and the second parameter b is calculated by a second neural network 22. The first and second neural networks 20, 22 are preferably trained independently of each other. The number of neural networks used to determine the calculated value 16 is equal to n+1. The first neural network 20 is trained with training data a₁ to aₘ and the second neural network 22 is trained with training data b₁ to bₖ.

### LIST OF REFERENCE SYMBOLS

Pᵢₙ Heat input
Pₒᵤₜ Heat dissipation
T_{R} Input value
ΔT Temperature change
a First parameter
b Second parameter
10 Process
12 Vehicle device
14 Drive train device
16 Calculated value
18 Analytical correlation
20 First neural network
22 Second neural network

1. A method for operating a vehicle device which is dependent on at least one calculated value and comprises the following steps:
determining the calculated value with an analytical correlation depending on at least one first parameter and second parameter of the vehicle device and an input value associated with the vehicle device;
calculating the first parameter by a first neural network; and
calculating the second parameter by a second neural network.

2. The method according to claim 1, further comprising at least one of measuring or calculating the input value based on a physical quantity of the vehicle device.

3. The method according to claim 1, further comprising training the first and second neural networks separately from one another.

4. The method according to claim 1, wherein the determined calculated value is the input value of a further determination of the calculated value temporally following the determination.

5. The method for operating a vehicle device according to claim 1, wherein the analytical correlation is represented by an n-th order polynomial.

6. The method according to claim 5, wherein a number of parameters of the analytical correlation including the first and second parameters is equal to n+1.

7. The method according to claim 5, wherein a number of neural networks used to determine the calculated value and including the first and second neural networks is equal to n+1.

8. The method according to claim 1, wherein at least one of: the calculated value indicates a temperature change, the first parameter indicates a heat input, the second parameter indicates a heat dissipation or the input value indicates a temperature.

9. A vehicle device which is operable according to the method of claim 1.

10. The vehicle device according to claim 9, wherein the vehicle device is a drive train device of a vehicle drive train.

11. A method for operating a vehicle device which is dependent on at least one calculated value and comprises the following steps:
determining the calculated value with an analytical correlation depending on at least one first parameter and second parameter of the vehicle device and an input value associated with the vehicle device;
calculating the first parameter by a first neural network;
calculating the second parameter by a second neural network; and
iteratively redetermining the calculated value using the prior calculated value as the input value associated with the vehicle device.

12. The method according to claim 11, further comprising at least one of measuring or calculating the input value based on a physical quantity of the vehicle device.

13. The method according to claim 11, further comprising training the first and second neural networks separately from one another.

14. The method for operating a vehicle device according to claim 11, wherein the analytical correlation is represented by an n-th order polynomial.

15. The method according to claim 14, wherein a number of parameters of the analytical correlation including the first and second parameters is equal to n+1.

16. The method according to claim 14, wherein a number of neural networks used to determine the calculated value and including the first and second neural networks is equal to n+1.

17. The method according to claim 11, wherein at least one of: the calculated value indicates a temperature change, the first parameter indicates a heat input, the second parameter indicates a heat dissipation or the input value indicates a temperature.

18. A vehicle device which is operable according to the method of claim 11.
